(19) United States
(12) Patent Application Publication
(10) Pub. No.: US 2005/0120808 A1
(43) Pub. Date: Jun. 9, 2005

(54) Platform balance

(75) Inventors: Richard A. Meyer, Chaska, MN (US); Douglas J. Olson, Plymouth, MN (US)

Correspondence Address: Steven M. Koehler;Westman, Champlin & Kelly, Suite 1600, 900 Second Avenue South, Minneapolis, MN, 55402-3319, US

(73) Assignee: MTS Systems Corporation, Eden Prairie, MN (US)

(21) Appl. No.: 11/003,943

(22) Filed: Dec. 3, 2004

Related U.S. Application Data
(60) Provisional application No. 60/526,954, filed on Dec. 4, 2003.

(51) Int. Cl. G01D 7/00

(52) U.S. Cl. 73/862.41

(57) ABSTRACT

The present disclosure is directed to a platform balance that is suitable for transmitting forces and moments in a plurality of directions. The platform balance is adapted to support a test specimen, such as a large vehicle, in a test environment such as a wind tunnel. The platform balance includes a frame support and at least three spaced-apart transducers coupled to the frame support. Each of the transducers is sensitive about two orthogonal sensed axes. The transducers cooperate to provide signals indicative of forces and moments with respect to at least two orthogonal axes. Each transducer includes a transducer body having a support coupled to a sensor body along an axis of compliance. The sensor body is adapted to deflect about the two orthogonal sensed axes where the sensed axes are mutually orthogonal to the axis of compliance.

### REFERENCE TO CO-PENDING APPLICATION

This patent application claims priority to co-pending U.S. application for patent filed on Dec. 4, 2003, having Ser. No. 60/526,954, and entitled “Platform Balance,” which is incorporated by reference in its entirety into this disclosure.

### BACKGROUND OF THE INVENTION

The present disclosure relates to devices that transmit and measure linear forces along and moments about three orthogonal axes. More particularly, the present disclosure relates to devices that are particularly well suited to measure forces and moments upon a test specimen in a test environment, such as in a wind tunnel.

The measurement of loads, both forces and moments, with accuracy and precision is important to many applications. A common use, where several moments and forces need to be measured, is in the testing of specimens in a wind tunnel. Test specimens can be placed on a platform balance located in a pit of the wind tunnel. The platform balance can be adapted to receive a vehicle or other large test specimen, rather than merely a scale model of the vehicle. Actual vehicles, rather than scale models of the vehicles, allows the designer to determine actual measurements of prototypes, rather than merely inferential measurements. If the test specimen is a vehicle with wheels, the platform balance can be equipped with a rolling belt to rotate the wheels, which can make a significant improvement in measurement accuracy.

Six components of force and moment act on a test specimen on the platform balance in the wind tunnel. These six components are known as lift force, drag force, side force, pitching moment, yawing moment, and rolling moment. The moments and forces that act on the test specimen are usually resolved into three components of force and three components of moment with transducers that are sensitive to the components. Each of the transducers carries sensors, such as strain gages, that are connected in combinations that form Wheatstone bridge circuits. By appropriately connecting the sensors, resulting Wheatstone bridge circuit unbalances can be resolved into readings of the three components of force and three components of moment.

Platform balances have a tendency to be susceptible to various physical properties of the test environment that can lead to inaccurate measurements without additional compensation. For example, temperature transients in the wind tunnel can result in thermal expansion of the platform balance that can adversely affect the transducers. In addition, large test specimens are prone to create large thrust loads on the transducers that can cause inaccurate measurements. Accordingly, there is a continuing need to develop a platform balance suitable for use with large test specimens.

### SUMMARY OF THE INVENTION

The present disclosure is directed to a platform balance that is suitable for transmitting forces and moments in a plurality of directions. The platform balance is adapted to support a test specimen, such as a large vehicle, in a test environment such as a wind tunnel. The platform balance includes a frame support and at least three spaced-apart transducers coupled to the frame support. Each of the transducers is sensitive about two orthogonal sensed axes. The transducers cooperate to provide signals indicative of forces and moments with respect to at least two orthogonal axes. In one example, the frame support includes a first perimeter frame and a second perimeter frame. The platform balance of this example includes four spaced-apart transducers coupling the first perimeter frame to the second perimeter frame. Transducers sensitive about two orthogonal sensed axes do not suffer from the effects of thermal expansion of the frame support and reject the large thrust loads present in transducers sensitive about three orthogonal sensed axes.

The present disclosure is also directed to a transducer body having a support coupled to a sensor body along an axis of compliance. The sensor body is adapted to deflect about the two orthogonal sensed axes where the sensed axes are mutually orthogonal to the axis of compliance. In one aspect, the support includes a pair of clevis halves disposed on opposite sides of the sensor body along the axis of compliance.

### BRIEF DESCRIPTION OF THE FIGURES

FIG. 1 is a plan view of a platform balance constructed in accordance with the present disclosure.

FIG. 2 is an elevation view of the platform balance of FIG. 1 having additional features and is suitable for receiving a test specimen.

FIG. 3 is an elevation view of the platform balance of FIG. 2, and having an exemplary test specimen.

FIG. 4 is a top view of a transducer constructed in accordance with the present disclosure and included in the platform balance of FIG. 1.

FIG. 5 is a front view of the transducer of FIG. 4.

FIG. 6 is a side view of the transducer of FIG. 4.

FIG. 7 is a detailed view of a portion of the transducer of FIG. 4.

FIG. 8 is a side view of another transducer constructed in accordance with the present disclosure.

### DETAILED DESCRIPTION OF THE ILLUSTRATIVE EMBODIMENT

This disclosure relates to devices and structures that transmit and measure linear forces along and moments about three orthogonal axes. The disclosure, including the figures, describes a platform balance and included transducers with reference to a several illustrative examples. For example, the disclosure proceeds with respect to frame supports attached to multi-part transducer assemblies described below. However, it should be noted that the present invention could be implemented in other devices or structures and transducers, as well. The present invention is described with respect to the frame supports and transducer assembly for illustrative purposes only. Other examples are contemplated and are mentioned below or are otherwise imaginable to someone skilled in the art. The scope of the invention is not limited to the few examples, i.e., the described embodiments of the invention. Rather, the scope of the invention is defined by reference to the appended claims. Changes can be made to the examples, including alternative designs not disclosed, and still be within the scope of the claims.

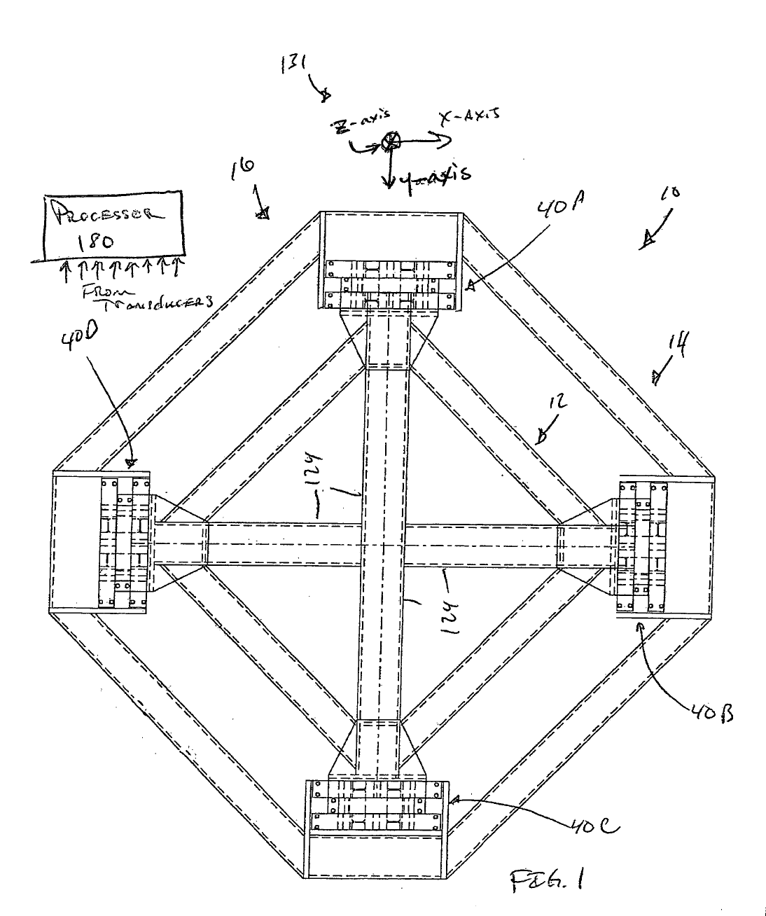

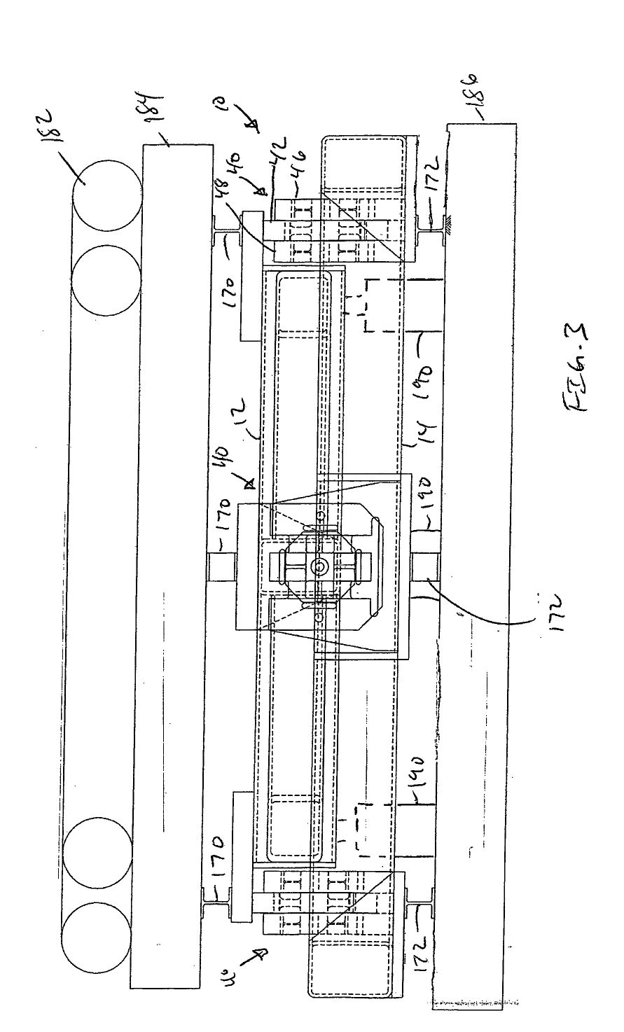

An exemplary embodiment of a platform balance 10 of the present disclosure is illustrated in FIGS. 1-3. In the embodiment illustrated, the platform balance 10 can include a first frame support 12 and a second frame support 14. A plurality of transducer assemblies 16, herein four although any number three or more can be used, couple the first frame support 12 to the second frame support 14. The platform balance 10 can be used to measure forces and moments applied to a test specimen of nominally large weight or mass such as a vehicle, engine, plane, etc. The frame supports 12 and 14 are nominally unstressed reaction frames, wherein each of the transducers comprises a two-axis force transducer. Various levels of flexure isolation can be provided in the platform balance 10 to provide increased sensitivity, while nominally supporting large masses.

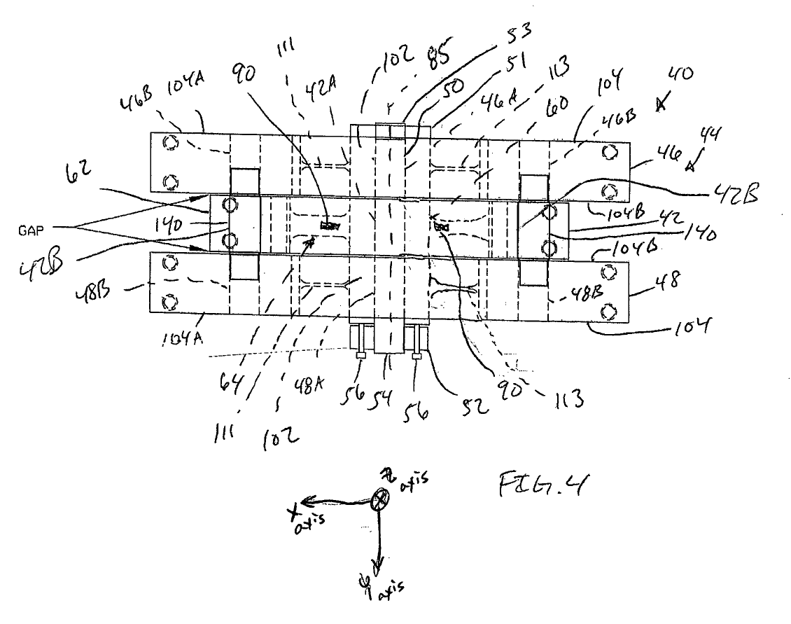

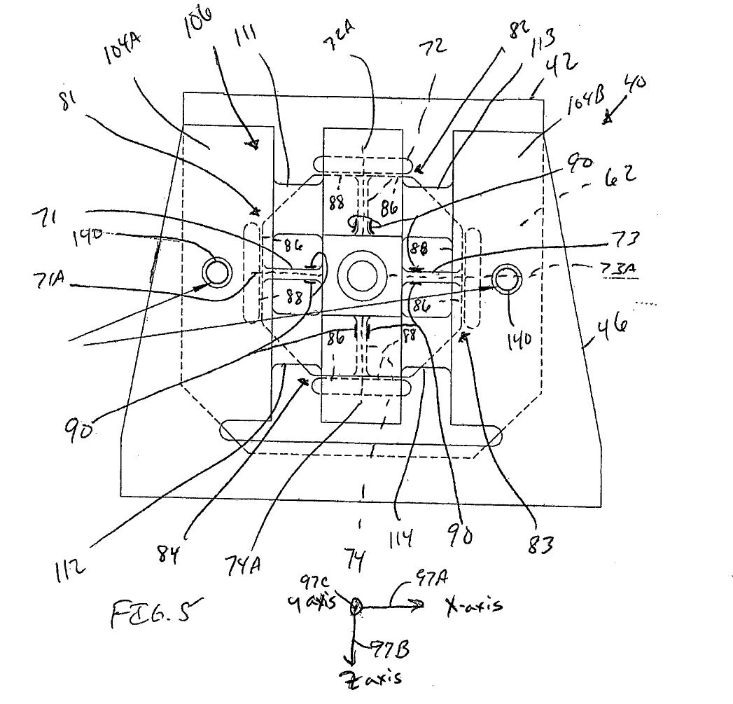

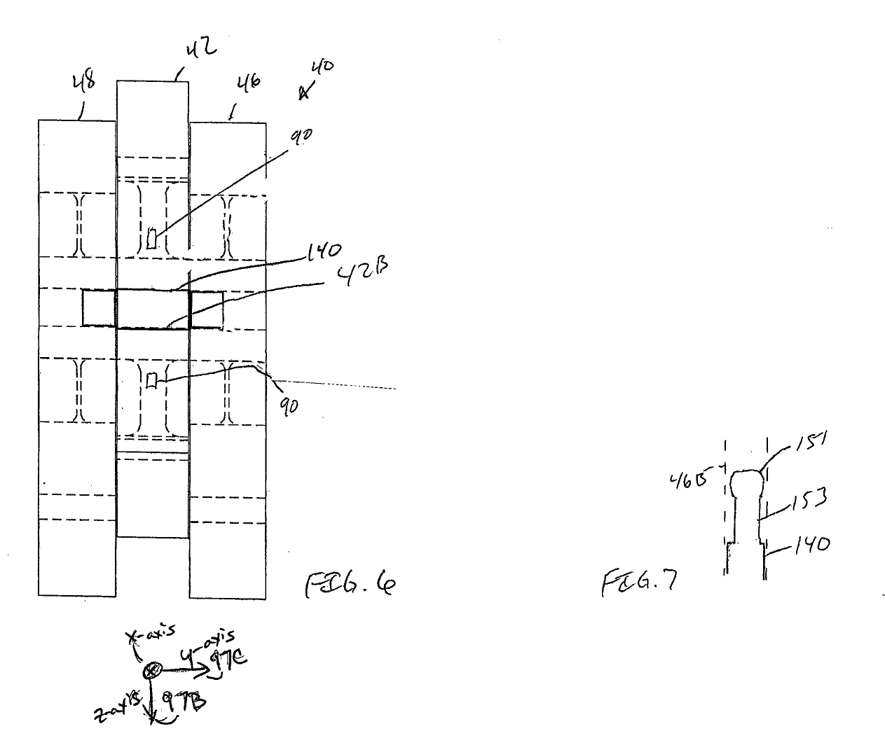

Referring to FIGS. 4-6, one of the transducer assemblies is illustrated at 40, wherein each of the transducer assemblies 16 is preferably similarly constructed. The transducer assembly 40 includes a sensor body 42 and a clevis assembly 44. The clevis assembly 44 includes a first clevis half 46 and a second clevis half 48. The sensor body 42 is disposed between the clevis halves 46 and 48 and joined together with a suitable fastener. In the embodiment illustrated, the fastener comprises a bolt or threaded rod 50 extending through apertures 48A, 42A and 46A of the clevis half 48, sensor body 42 and clevis half 46, respectively. A nut 51 is provided on an end 53 of rod 50 and a super nut 52 is threaded upon an end 54 of the threaded rod 50. A plurality of set screws 56 extends through the apertures in the nut 52 to engage an end of the clevis half 46. Tightening of the set screws 56 allows high clamping pressures to be achieved efficiently and at reduced torque values on each of the set screws 56 rather than through the use of a nut 52 by itself. It should be noted that although center portions of the devises 46 and 48 will engage or contact the center portion of the sensor body 42 about the apertures 46A, 42A and 48A, gaps are otherwise provided between each of the clevis halves 46 and 48 and the sensor body 42 so as to allow the sensor body 42 to move relative to the clevis halves 46 and 48.

The sensor body 42 is preferably integral, being formed of a single unitary block of material. The sensor body 42 includes a ridged central hub 60, herein including the aperture 42A, and a ridged perimeter body 62 that is concentric with, or disposed about, the central hub 60. A plurality of flexure structures 64 (herein flexure beams 64 although other forms could be used) join the central hub 60 to the perimeter body 62. In the embodiment illustrated, the plurality of flexure beams 64 comprises four straps 71, 72, 73 and 74. Each of the straps 71-74 extend radially from the central hub 60 to the perimeter body 62 along corresponding longitudinal axes 71A, 72A, 73A and 74A. Preferably, axis 71A is aligned on axis 73A, while axis 72A is aligned with axis 74A. In addition, axes 71A and 73A are perpendicular to axes 72A and 74A. Although illustrated wherein the plurality of flexure beams 64 equals four, it should be understood that any number of straps three or more can be used to join the central hub 60 to the perimeter body 62. Preferably, the flexure beams 64 are spaced at equal angular intervals about a. central axis indicated at 85.

Flexure members 81, 82, 83 and 84 join an end of each flexure beam 71-74, respectively, to the perimeter body 62. The flexure members 81-84 are compliant with displacements of each corresponding flexure beam 71-74 along the corresponding longitudinal axes 71A-74A. In the embodiment illustrated, the flexure members 81-84 are identical and include integrally formed flexure straps 86 and 88. The flexure straps 86and 88 are located on opposite sides of each longitudinal axes 71A-74A and joined to corresponding flexure beam 71-74 and to the perimeter body 62.

A sensing device measures displacement or deformation of portions of the sensor body 42. In the body illustrated, a plurality of strain sensors 90 are mounted on the flexure beams 64 to sense strain therein. Although the plurality of sensors 90 can be located on the plurality of flexure beams 64 to provide an indicated of shear stresses, in the embodiment illustrated, the strain sensors are mounted conventionally to provide an output signal indicative of bending stresses in the flexure beams 64. In the embodiment illustrated, eight strain sensors are provided on the sensor body 42 of each transducer 40 wherein two conventional Wheatstone bridges are formed. A first Wheatstone bridge or sensing circuit is conventionally formed from the strain sensors provided on flexure beam 71 and 73, while a second Wheatstone bridge or second sensing circuit is formed from the strain sensors provided on flexure beams 72 and 74. The plurality of sensors 90 can comprise resistive strain gauges. However, other forms of sensing devices such as optically based sensors or capacitivity based sensors can also be used to measure deformation or displacement of the flexure beams 64, or other portions of the sensor body 42 such as each of straps 86 and 88 if desired.

Output signals from the sensing devices are indicative of force components transmitted between the central hub 60 and the perimeter body 62 in two degrees of freedom. For purposes of explanation, a coordinate system 97 can be defined wherein an X-axis 97A is aligned with the longitudinal axes 71A and 73A; a Z-axis 97B is aligned with the vertical axes 72A and 74A and a Y-axis 97C is aligned with the axis 85.

In the embodiment illustrated, each of the transducer assemblies 16 measures two forces. Specifically, a force along the X-axis is measured as bending stresses created in the flexure beams 72 and 74 since the flexure members 81 and 83 on the ends of the flexure beams 71 and 73 are compliant in this direction. Similarly, a force along the Z axis is measured as bending stresses in the flexure beams 71 and 73 since the flexure members 82 and 84 on the ends of the flexure beams 72 and 74 are compliant in this direction.

The transducer 40 is also compliant along the axis 85, because of flexures provided on the clevis assembly 44. In the. embodiment illustrated, the clevis assembly 44 is formed of substantially identical clevis halves 46 and 48. In the illustrated embodiment, the sensor 42 is the “inner member” of the transducer body. Other embodiments are contemplated. For example, a single clevis half by itself could also be used. Still further, a single clevis half as an inner member connected to two sensors, which is described later with respect to FIG. 8 could also be used.

In the embodiment illustrated, each clevis half 46 and 48 includes a central hub 102 through which, in the embodiment illustrated, apertures 46A and 48A are provided, and a rigid outer body 104. A flexure mechanism couples the rigid central hub 102 with the outer body 104. In the embodiment illustrated, a plurality of flexure straps 106 are provided with a first pair of flexure straps 111 and 112 extending from the central hub 102 to a first portion 104A of the outer body 104 and a second pair of flexure straps 113 and 114 extending from the central hub 102 to a second portion 104B of body 104. However, it should be noted that other forms of flexure members or mechanism can be used between the rigid hub 102 and the outer body 104 to allow compliance along axis 85 if desired. Such forms can include other integral flexure mechanisms such as a diaphragm(s), or multi-component assemblies having flexible couplings such as slides or pivot connections.

Referring FIGS. 1-3, the sensor body 42 of each of the transducer assemblies 40 is joined to the frame support 12, while each of the clevis halves 46 and 48 of each transducer assembly 40 is joined to a frame support 14. In the embodiment illustrated, mounting plates 120 are used to couple the sensor bodies 42 to the frame support 12, while mounting plates 122 are used to join the clevis halves 46 and 48 to the frame support 14. In this manner, the frame support 12 provides an inner perimeter frame, while the frame support 14 provides an outer perimeter frame. Use of the mounting plates 120 and 122 allows the frame supports 12 and 14 to be nested thereby reducing an overall height of the platform balance 10.

Each of the frame supports 12 and 14 comprise continuous hollow box beams formed in a perimeter so as to provide corresponding stiff assemblies. The frame support 12 holds the sensor bodies 42 in position with respect to each other, while the frame support 14 holds the clevis assemblies 44 in position with respect to each other. Stiffening box frame members 124 can also be provided in the support frame 12 as illustrated.

As appreciated by those skilled in the art, outputs from each of the two-axis sensing circuits from each of the transducer assemblies 16 can be combined so as to sense or provide outputs indicative of forces and moments upon the platform balance in six degrees of freedom. It should be noted that the flexure mechanisms of the clevis assembly 44 causes the transducers 16 to operate in a manner similar to how the flexure members 81-84 provide compliance in the sensor body 42.

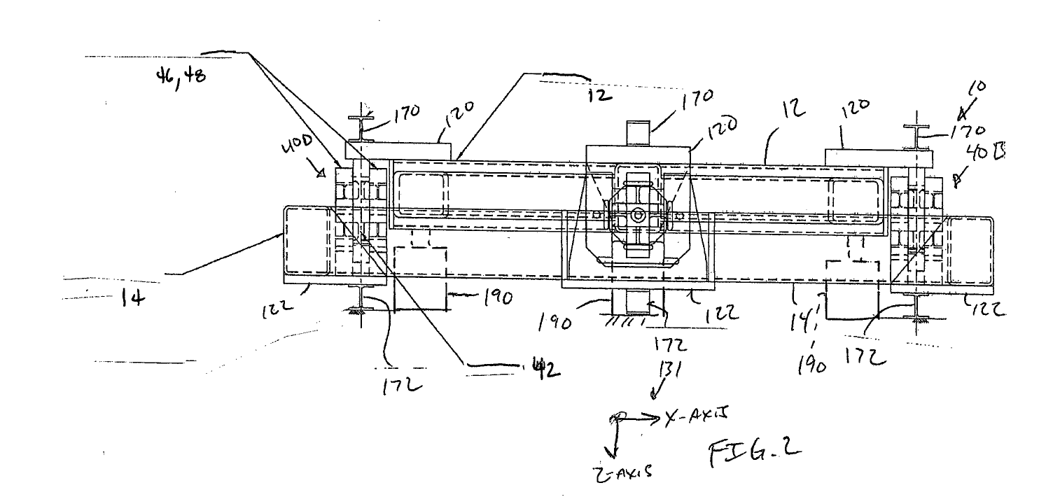

A coordinate system for platform 10 is illustrated at 131 in FIGS. 1 and 2. Output signals from transducer assemblies 40A and 40C are used to measure forces along the X-axis, because transducer assemblies 40B and 40D are compliant in this direction. Likewise, output signals from transducer assemblies 40B and 40D are used to measure forces along the Y-axis, because transducer assemblies 40A and 40C are compliant in this direction. Outputs from all of the transducers 40A-40D are used to measure forces along the Z-axis. Overturning moments about the X-axis are measured from the output signals from transducers 40A and 40C; while overturning moments about the Y-axis are measured from the output signals from transducers 40B and 40D; and while overturning moments about the Z-axis are measured from the output signals from transducers 40A-40D. Processor 180 receives the output signals from the sensing circuits of the transducers 40 to calculate forces and/or moments as desired, typically with respect to the orthogonal coordinate system 131.

As described above, the platform can comprise four two-axis transducer assemblies. This particular design can have advantages over an embodiment having four three-axis (or more) transducer assemblies. In addition to the rejection of thermal expansion of the frames 12 and 14 relative to each other during lab or tunnel temperature transients, the platform 10 does not have to reject a relatively large thrust load on each of the four transducer assemblies (the clevis flexures are all very soft in thrust (along axis 86) thus shedding load to the two orthogonal two-axis transducer assemblies when an x or y side load is applied). This allows the platform 10 to be more optimally tuned for the four sensing flexure straps in each two-axis sensor body 42 than if the assembly was trying to react and measure thrust at the four transducer assembly positions about the platform as in three or more than three axis transducer assemblies. The design allows cross axis dimensions and I/c of orthogonal flexure beams to be changed independently to optimize sensitivity. For example, two can be thicker than the other two and can be thickness variable as well. If the transducer assemblies were three axis transducers and this occurred, two of the beams in line with each other would be stiffer and give different outputs from the orthogonal pair and thus make the sensor behave strangely with off axis or combined loadings. Lack of need to measure and react to thrust also allows higher stress and strain designs since there is no second bending stress tensor which would add bending in an additional axis at beam root connections to inner central hubs. Again higher sensitivity, higher resolution and higher signal to noise ratio with greater span on scalability both absolute and measured components relative to each other.

In a further embodiment, over travel stop mechanisms are provided in each of the transducer assemblies 16 so as to prevent damage to the sensor bodies 42 or flexure mechanisms of the clevis assemblies 44. Referring back to FIGS. 4-6, one or more pins 140 are provided so as to limit displacement of the sensor body 42 relative to the clevis assembly 44. In the embodiment illustrated, apertures 46B, 48B, 42B are provided in the clevis halves 46 and 48 and the sensor body 42, respectively. The pin 140 is secured, for example, to the sensor body 42 such as by a press fit so that extending portions of the pin 140 extend into the apertures 46B and 48B of the clevis halves 46 and 48 and are nominally spaced apart from inner walls thereof. If displacement of the displaceable portions of the sensor bodies 42 exceeds that desired relative to the bodies of the clevis halves 46 and 48, extending portions of the pin 140 will contact the inner wall of the apertures 46B and/or 48B provided in the clevis half 46 and/or 48 thereby coupling the perimeter body 62 of the sensor body 42 with the outer bodies 104 of the clevis halves 46 and 48 to prevent damage to the flexure straps or mechanism. Note that the perimeter body 62 can be appropriately spaced from the clevis half (halves) 46 and/or 48 to provide overtravel protection. In particular, the perimeter body 62 can engage the clevis halves 46 and/or 48, if displacement along axis 85 exceeds a selected distance.

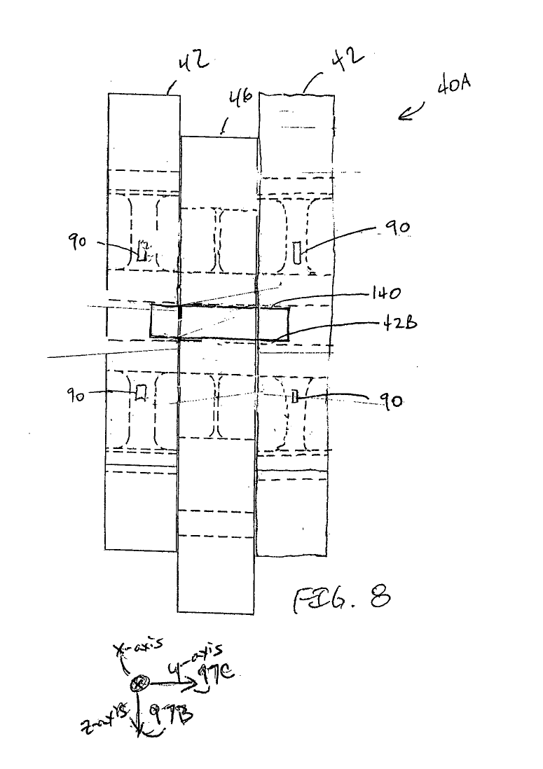

Although the sensor body 42 and clevis halves 46 and 48 can be formed from any suitable material, in one embodiment, the sensor body 42 is formed from steel, while the clevis halves are formed from aluminum. Each of the pins 140 can be formed from hardened steel and if necessary, hardened bushings can be provided in the apertures 46B, 48B of the clevis halves 46 and 48 to engage the remote portions of the pin 140. It should be noted that the extending portions of the pin 140 can be provided with a curved or spherical surface 151, as illustrated in FIG. 7, relative to a shank portion 153 so as ensure distributed contact of the pin 140 with the inner wall of the apertures 46B, 48B formed in the clevis halves 46 and 48.

It should also be noted that depending on the intended application the sensor body 42 and clevis half or halves can be formed a single unitary body.

FIG. 8 shows an alternative embodiment of the transducer, i.e., transducer 40A and corresponding body. Like parts are indicated with like reference numerals. In this embodiment, one of the clevis halves 46 of FIGS. 4-6 becomes the inner member. Two sensor members 42 from FIGS. 4-6 become the clevis halves. In this example and unlike the previous examples, the inner member is not instrumented. Rather, the sensor member structures of the previous embodiment are instrumented with sensors, but in this embodiment function as clevis halves. Suitable sensors such as strain gauges 90 are still connected to the members 42. The illustrated example includes twice as many sensors 90 as in the embodiment of FIGS. 4-6. In order to provide usable outputs, the sensor signals can be combined in each transducer such as by combining or summing the signals in Wheatstone bridges as is known in the art. The configuration of FIG. 8 is stiffer in the y-direction (as indicated in the coordinate system) than the embodiment of FIGS. 4-6. The embodiment of FIGS. 4-6, however, is stiffer in a moment about the x-axis than the embodiment of FIG. 8.

The platform balance 10 is particularly well suited for measuring force and/or moments upon a large specimen such as a vehicle in an environment such as a wind tunnel. In this or similar applications, the platform balance 10 can include flexures 170 isolating the frame support 12 and 14 from the test specimen and a ground support mechanism. In the embodiment illustrated, four flexures 170 are provided between each of the transducer assemblies 40, being coupled to the plates 120. Similarly, four flexures 172 are coupled to the mounting plates 122. The flexure 170, 172 thereby isolate the frame supports 12 and 14. The flexures 170, 172 are generally aligned with the sensor bodies 42 of each corresponding transducer assembly 40.

A counter balance system or assembly is generally provided to support the nominal static mass of the test specimen, other components of the operating environment such as roadways, simulators and components of the platform balance itself. The counter balance system can take any one of numerous forms such as airbags, hydraulic or pneumatic devices, or cables with pulleys and counter weights. An important characteristic of the counter balance system is that it is very compliant so as not to interfere with the sensitivity or measurement of the forces by the transducers assemblies 40 in order to measure all of the forces and moments upon the test specimen. In the embodiment illustrated, the counter balance system is schematically illustrated by actuators 190.

The platform balance 10 is particularly well suited for use in measuring forces upon a vehicle or other large test specimen in a wind tunnel. In such an application, rolling roadway belts 182 are supported by an intermediate frame 184 coupled to the flexure members 170. The rolling roadway belts 182 support the vehicle tires. In some embodiments, a single roadway belt is used for all tires of the vehicle. The platform balance 10 and rolling roadway belt assemblies 182 are positioned in a pit and mounted to a turntable mechanism 186 so as to allow the test specimen, for example a vehicle, to be selectively turned with respect to the wind of the wind tunnel.

The present invention has now been described with reference to several embodiments. The foregoing detailed description and examples have been given for clarity of understanding only. Those skilled in the art will recognize that many changes can be made in the described embodiments without departing from the scope and spirit of the invention. Thus, the scope of the present invention should not be limited to the exact details and structures described herein, but rather by the appended claims and equivalents

1. A platform balance suitable for transmitting forces and moments in a plurality of directions, the platform balance comprising:
a frame support; and
at least three spaced-apart transducers coupled to the frame support, each transducer sensitive about two orthogonal sensed axes wherein the at least three spaced-apart transducers cooperate to provide signals indicative of forces and moments with respect to at least two orthogonal axes.

2. The platform balance of claim 1 wherein the frame support includes a first perimeter frame and a second perimeter frame, and wherein the at least three spaced-apart transducers include four spaced-apart transducers coupling the first perimeter frame to the second perimeter frame.

3. The platform balance of claim 2 and further comprising a first set of flexures coupled to the first perimeter frame and adapted to engage a ground support, and a second set of flexures coupled to the second perimeter frame and adapted to engage a test specimen.

4. The platform balance of claim 3 wherein the second set of flexures are coupled to a belt frame adapted to engage a wheeled test specimen.

5. The platform balance of claim 2 wherein each transducer comprises a sensor body coupled to the second perimeter frame and a support coupled to the first perimeter frame, the sensor body being coupled to the support wherein the support is compliant in an axis of compliance, wherein the axis of compliance is orthogonal to a sensed axes of each transducer.

6. The platform balance of claim 5 wherein the support comprises two clevis halves disposed on opposite sides of the sensor body along the axis of compliance.

7. The platform balance of claim 6 wherein the first perimeter frame is coupled to the two clevis halves.

8. The platform balance of claim 5 wherein the support includes a single clevis disposed on a side of the sensor body along the axis of compliance.

9. The platform balance of claim 2 wherein the first and second perimeter frames include box beams.

10. The platform balance of claim 2 wherein the first and second perimeter frames are nested.

11. The platform balance of claim 2 wherein the frame support includes a stiffening frame coupled to the transducers.

12. The platform balance of claim 11 wherein the stiffening frame is directly coupled to the first perimeter frame.

13. A transducer body, comprising:
a support; and
a sensor body coupled to the support along an axis of compliance, wherein the sensor body is adapted to deflect about two orthogonal sensed axes, and wherein the sensed axes are mutually orthogonal to the axis of compliance.

14. The transducer body of claim 13 wherein the support includes a pair of clevis halves disposed on opposite sides of the sensor body and along the axis of compliance.

15. The transducer body of claim 13 wherein the sensor body includes a generally rigid peripheral member disposed about a spaced-apart central hub, wherein at least three flexure members couple the peripheral member to the central hub, and wherein the flexure members are spaced-apart from each other at generally equal angle intervals about the central hub.

16. The transducer body of claim 15 wherein the sensor body includes four flexure members.

17. The transducer body of claim 15 wherein the central hub is coupled to the support.

18. The transducer body of claim 13 wherein the sensor body is adapted to receive a plurality of sensors.

19. The transducer body of claim 13 wherein the support includes a compliant member and the transducer body further comprises a second sensor body disposed on a side of the compliant member opposite the first-mentioned sensor body and along the axis of compliance.

20. A platform balance suitable for use with a test specimen, the platform balance comprising:
means for transmitting loads of the test specimen in a plurality of directions; and
means for generating signals indicative of the loads along at least two orthogonal axes by sensing along at least three two orthogonal sensed axes.
